(19) United States
(12) Patent Application Publication
(10) Pub. No.: US 2008/0160387 A1
(43) Pub. Date: Jul. 3, 2008

(54) ELECTRIC POWER PACK THAT INCLUDES A FUEL CELL

(75) Inventor: Antonio DELFINO, Grolley (CH)

Correspondence Address: FITZPATRICK CELLA HARPER & SCINTO, 30 ROCKEFELLER PLAZA, NEW YORK, NY, 10112, US

(73) Assignee: MICHELIN RECHERCHE ET TECHNIQUE S.A., Granges-Paccot (CH)

(21) Appl. No.: 11/961,618

(22) Filed: Dec. 20, 2007

(30) Foreign Application Priority Data
Dec. 27, 2006 (FR) 06/11512

(51) Int. Cl. H01M 8/02; B01D 53/047

(52) U.S. Cl. 429/34; 429/12; 95/273; 96/108; 55/315

(57) ABSTRACT

To improve the way in which a fuel cell is installed, especially in the case of fuel cells on board electric traction vehicles, the oxygen needed for supplying the fuel cell is produced in situ by separating the nitrogen from the ambient air continuously, without a change of state. Thus, an electric power pack comprises a stack of electrochemical cell elements each possessing a cathode and an anode, in electrochemical coupling relationship with an electrolyte, and an electrical output circuit suitable for connecting the cathode and the anode through a load, a device for delivering fuel to the anode and an on-board oxygen generator based on a separator, for separating the oxygen and nitrogen of the ambient air without a change of state, in order to supply the cathode of said cell elements. According to a preferred embodiment, the separator is of the nitrogen pressure swing adsorption type. In one embodiment, the separator is supplied with compressed air by a first compressor and the oxygen delivered at its output is compressed further in order to supply the fuel cell. The whole assembly makes it possible to achieve an improved performance compromise for vehicle applications in which great autonomy is required.

### BACKGROUND OF THE INVENTION

1. Field of the Invention

The present invention relates to fuel cells, especially cells installed on board electric traction vehicles to generate the necessary current directly from an on-board fuel supply.

2. Prior Art

It is known that fuel cells produce electrical energy by an electrochemical oxidation-reduction reaction starting from hydrogen or another reducing material (the fuel) and oxygen (the oxidizer), without passing via conversion to mechanical energy. This technology seems promising for applications in the transport field of whatever nature, especially in motor vehicles.

A fuel cell comprises in general the series connection of individual cell elements, each essentially comprising an anode and a cathode coupled together in electrical conduction relationship by an electrolyte. One type of electrolyte that is very suitable for example for motor vehicle applications is a solid electrolyte essentially consisting of a polymer membrane that allows the passage of positive ions from the anode to the cathode.

In its normal operation, a hydrogen fuel cell consumes hydrogen (the fuel) and oxygen (the oxidizer) delivered by the ambient air or in the form of pure gas. The fuel cell is the site of an anode reaction via which hydrogen (H₂) is converted into hydrogen protons (2H⁺) which pass through the polymer membrane and into electrons (2e⁻) which flow in the external electrical circuit. At the same time, the fuel cell is the site of a cathode reaction via which the hydrogen protons (2H⁺) and the electrons (2e⁻) combine with oxygen (½O₂) in order to produce water (H₂O).

As regards the fuel, either there is a hydrogen supply, or the hydrogen that is needed is produced close to the fuel cell by means of a reformer, which is itself supplied for example with a hydrocarbon. In the case of a vehicle, the former solution requires an on-board hydrogen tank.

As regards the oxidizer, either the fuel cell is supplied with pure oxygen, which, in the case of an on-board fuel cell, implies the use of a pure oxygen tank on board the vehicle, or the fuel cell is supplied with compressed ambient atmospheric air, and the excess gas in which the proportion of oxygen has decreased is discharged downstream of the fuel cell. The latter solution has the merit of perpetuity of oxidizer supply. However, it suffers from the fact that the efficiency of the fuel cell supplied with air is lower than that obtained with pure oxygen. This means that, for the same useful power, a much heavier and more bulky cell has to be provided in the case in which the supply is carried out directly from the ambient air than in the case of supply with pure oxygen.

Of course, the reverse problem is encountered with pure-oxygen supplies, namely the fact that the better efficiency of the cell is counteracted by the need to supply pure oxygen on board the vehicle. Given that in this case a hydrogen tank is also essential, this means two storage tanks on board the vehicle. The capacity, and therefore the size, of these tanks depends on autonomy that it is desired to confer on the vehicle. The greater the desired autonomy, (in terms of range and/or operating time), the bulkier, and therefore heavier, the tanks have to be. Thus, beyond a certain autonomy, the saving in compactness of the fuel cell resulting from the use of pure oxygen is cancelled out by the increase in size and weight of the oxygen tank needed to achieve the performance of the vehicle.

It would therefore be advantageous to be able to improve the way in which a fuel cell is installed, especially in the case of cells intended to be on board for operating a vehicle, in particular an electrically powered vehicle.

### BRIEF DESCRIPTION OF THE INVENTION

For this purpose, the present invention is directed to a fuel cell which operates with a supply of oxygen gas that is obtained by separating nitrogen from ambient air, which is carried out in situ continuously on board a vehicle. More specifically, in accordance with the invention, an electric power pack is provided having a fuel cell comprising a stack of individual cell elements, each element comprising a cathode and an anode in electrochemical relationship with an electrolyte. The fuel cell comprises electrical output terminals specific for connecting the power pack to an electrical load. The power pack includes a device for delivering fuel to the fuel cell, and comprises a system for supplying the fuel cell with an oxygen-based oxidizer gas drawn from the ambient air, said system comprising at least one separator for separating the components of air by filtration without a change of state.

In a preferred embodiment the system includes a separator for separating the components of ambient air by filtration without a change of state; an air compressor, for supplying the inlet of the separator with air at a first superatomospheric pressure; and a compressor for compressing oxygen-rich oxidizer gas available at the outlet of the separator for supplying the cathode inlet of the fuel cell with oxidizer gas at a second superatmospheric pressure that is preferably greater than the first atmospheric pressure. The system also preferably includes an electric traction motor that is supplied by the fuel cell.

In a preferred embodiment, the separator is of the pressure swing adsorption (PSA) type. An inlet compressor connected to the ambient air is then provided for supplying the inlet of the separator with pressurized air to be decomposed. Furthermore, it may be advantageous to choose to compress the oxygen-enriched gas collected at the outlet of the separator in order to supply the cathode supply circuit of each cell element of the fuel cell at a pressure above that of the air feeding the separator. With a nitrogen pressure swing adsorption separator, operating with zeolite filters, the air inlet pressure is typically around 2 bar absolute. At its outlet, the oxidizer gas has an oxygen content of greater than 95%. The oxidizer gas is then preferably compressed to 3 or 4 bar absolute before it is taken into the cell elements of the fuel cell for the purpose of optimizing the electrochemical conversion efficiency.

Also provided is a method for supplying consumable material to the hydrogen fuel cell on board a vehicle with an electronic traction motor supplied by the fuel cell wherein ambient air of the vehicle is used by compressing it and delivering oxidizer gas progressively to the fuel cell as required for its operation. The method comprises compressing the ambient air to a first superatmospheric pressure, separating the compressed air to form oxygen-enriched gas, compressing the oxygen-enriched gas to a second superatmospheric pressure, and sending it to the oxidizer gas inlet at the cathode of the fuel cell.

Equipment for separating the components of air that does not involve heavy and bulky liquefaction and distillation installations has already been available for a number of years. Interest in these techniques has certainly grown in the aeronautical industry, in connection in particular with the transportation of people. The ever higher flight altitudes and the corresponding rarefaction of the ambient air dictate in fact the use of installations suitable for generating an atmosphere that allows living beings to breathe conveniently throughout the duration of flights, despite the rarefaction of the ambient air.

Thus, to meet the requirements of the pilots of military aircraft, air separation techniques using physical methods without a change of state have been applied on board these aircraft. The generators used for these on-board applications have the generic name of OBOGS (On-Board Oxygen Generation Systems).

They rely on technologies that appeared more than 30 years ago, these being based on the properties of certain materials for selectively filtering oxygen or nitrogen of the air by processes involving adsorption in zeolites or selective permeation through polymer membranes.

The separation of air by pressure swing adsorption (PSA) is one of these techniques. It is based on the properties of certain zeolite structures for adsorbing nitrogen, preferably oxygen, at a pressure above atmospheric pressure, thereby enabling the two gases to be separated. The nitrogen may then be desorbed by lowering the pressure surrounding the molecular sieve made of a zeolite. Patent document EP 026694 A1 published on 8 Apr. 1981 provides one example of a two-column PSA separation process.

Documents EP 1 375 349 B1 published on 1 Jun. 2005 and WO 2005/0029966 A1 both describe applications of the aforementioned techniques for on-board purposes, by themselves or in combination with inert gas generators operating on the same principle.

However, it appears that the use of these techniques in the on-board field has remained limited to essentially rather very specific applications not requiring relatively high flow rates, even though the published works reflect a certain interest in the containment of emergency atmosphere conditioning in commercial aeronautics or for producing nitrogen-based inert atmospheres with a view to limiting combustion or the risk of explosive atmospheres developing in confined spaces.

Now, the Applicant has noticed that, faced with current developments in fuel cells in the automotive field, which require substantial gas flow rates, it is possible to achieve useful compromises between on-board weight and desirable performance requirements if the abovementioned oxygen generation principles are adapted to delivering an oxidizer gas to fuel cells for supplying electric traction vehicles.

Thus, a motor vehicle weighing 850 kg has been fitted with a hydrogen combustion fuel cell of the polymer electrolyte type, comprising a stack of about 100 cell elements delivering a nominal electric power of 30 kW.

The assembly is supplied with hydrogen from a 120-litre pressurized hydrogen reserve. With this reserve, the fuel cell is capable of delivering the energy needed to give the vehicle a range of 400 kilometers when traveling on average roads (in towns and in the country) with suitable performance levels for the category of vehicle mentioned above. The fuel cell is supplied with an oxygen-enriched gas from a separator that separates the components of the ambient air on board the vehicle, of the OBOGS type, which delivers an oxygen-enriched flow rate compatible with the indicated performance levels of the vehicle. The weight of the OBOGS is 60 kg. It is also known to supply a fuel cell with pure oxygen. In this case, to achieve the kilometer range indicated above, the weight of a tank of pure oxygen pressurized to 350 bar amounts to 66 kg. For this range, 16 kg of oxygen is required, hence a total weight of 82 kg. For a longer range, the amount of pure oxygen on board and the weight of the tank increase correspondingly. However, the weight of the OBOGS remains constant, since this is independent of the range.

Thus, it turns out that the invention makes it possible to produce vehicles equipped with fuel cells operating on pure oxygen, this being advantageous in areas of application to vehicles having a long radius of action, heavy goods vehicles operating over long distances, or very light vehicles requiring a high level of autonomy, such as for example in the aircraft field, etc.

In addition to the advantages inherent to the supply formulation according to the invention, other advantages may be developed according to certain features of the oxidizer gas generator in question. Insofar as these generators are based on separating the nitrogen and other gases from air, arrangements may be provided to have, alongside an oxygen-rich first gas outlet connected to a line for supplying the cathode with oxidizer, a second outlet, for gas rich in elements that are inert with respect to oxidization reactions, especially nitrogen. This second outlet may then be connected to a shell suitable for surrounding the fuel cell with an essentially inert atmosphere.

According to another complementary aspect of the invention, this second outlet may be connected selectively to the lines for supplying the fuel cell with gas in order to make it easier to extinguish (i.e., turn off) the latter in response to a command to interrupt its electrical output circuit. Preferably in this case, these pressurized gases are used directly without having to expand them at the outlet of the separator.

To further improve the overall efficiency of the installation, when the second outlet of the separator conveys inert gaseous products under a pressure greater than atmospheric pressure, some or all of the energy required to compress these products may be recovered through a discharge circuit by sending them to the inlet of a mechanical energy recuperator, such as a turbine, the mechanical output of which helps in driving the compressor comprising the inlet air of the separator. The expanded gases at the outlet of the turbine may then be used to form an inert atmosphere around just the fuel cell or around the entire installation.

### BRIEF DESCRIPTION OF THE DRAWINGS

Other features and advantages of the invention will become apparent from the following description, with reference to the appended drawings which show, by way of non-limiting examples, embodiments of the subject of the invention, and in which:

FIG. 1 is a highly schematic representation of a hydrogen fuel cell being supplied with oxygen from the ambient air compressor;

FIG. 2 is a highly schematic representation of a hydrogen fuel cell being supplied from a system for separating the components of the ambient air by pressure swing adsorption; and

FIG. 3 shows schematically the operating principle of a separator for separating the components of air operating by pressure swing adsorption (PSA), as used in the system shown in FIG. 2.

### DESCRIPTION OF ONE OR MORE EMBODIMENTS OF THE INVENTION

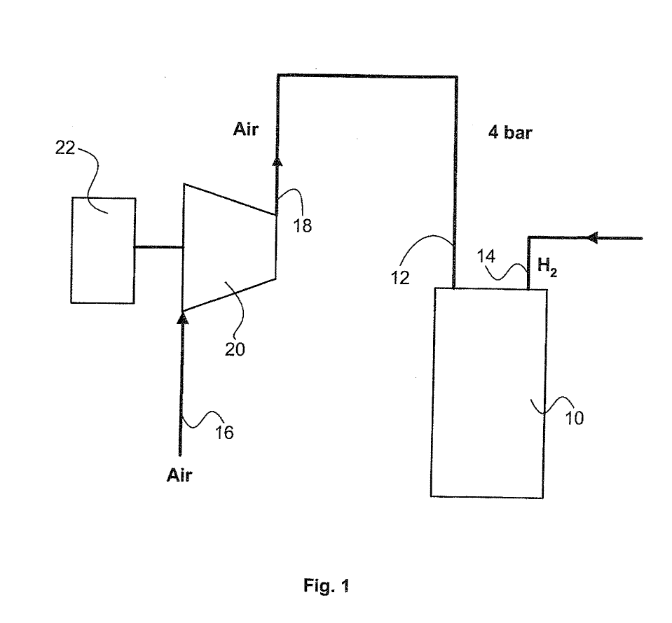

In FIG. 1, a hydrogen fuel cell 10 is made up of a stack of individual cell elements or electrolytic elements, each having an anode and a cathode that are coupled electrochemically via a solid electrolyte. The fuel cell 10 has two gas supply inlet lines. In this example, the first line 12 receives air at a pressure of about 4 bar absolute (i.e. 3 bar above atmospheric pressure), and therefore delivers oxygen as oxidizer, mixed with the other components of air, to the cathode inlet of each element of the fuel cell. The compressed air reaching the inlet of the line 12 is delivered from the outlet 18 of a compressor 20 connected to an air intake 16. The second line 14 is supplied with gaseous hydrogen from a hydrogen tank (not shown). It is connected to the anode inlet of each of the elements of the fuel cell 10 in a known manner (not shown).

The compressor 20 is driven by an electric motor 22, the energy of which comes from the fuel cell. Apart from supplying oxidizer, the pressurized air thus brought to the fuel cell fulfils two other functions. Firstly, it delivers, at the inlet on the cathode side of the individual cell elements, a duly metered amount of moisture in order to ensure conduction of the ions within the solid electrolyte membrane. Secondly, it is used to expel the water produced in the gas distribution channel and discharge it to the outside. The pressure drop created inside the gas circuit of the fuel cell must be sufficient to fulfill this function.

Now, it is known that a fuel cell operates with a certain excess of oxidizer gas relative to the precise stoichiometric proportions. For a fuel cell supplied with pure oxygen, the oxygen excess is around 20% (i.e. a stoichiometry of 1.2). However, for a fuel cell supplied with ambient air, it is necessary to operate with a much higher excess of air so that there is sufficient oxygen as oxidizer at the inlet of the fuel cell in order to consume all the hydrogen ions. This is because the ambient air contains about 80% of nitrogen, which is an inert gas completely useless for the reaction. However, progressively as the air flows along the distribution channels between the inlet and the outlet of the bipolar plates, it is depleted of oxygen, since the latter is ionized and then recombined with the hydrogen ions to form water. To compensate for this depletion, it is necessary to increase the air excess. It is for this reason that a fuel cell supplied with ambient air operates with an air excess of the order of 100% (i.e. a stoichiometry of 2.0). Hence there is a considerable energy loss in compressing a very large quantity of air. Furthermore, the humidification of the air, necessary at least at the fuel cell start-up phases, requires the use of a greater amount of water corresponding to operation with a large excess of air.

The energy consumption needed to pressurize the air is a factor that must be taken into account on the liability side of the energy balance sheet of the fuel cell, this consumption obviously placing a burden on the efficiency.

More generally, it would be desirable to improve the compromise between the various criteria to be taken into account for supplying fuel cells on partly or completely electric traction vehicles. Figuring among these criteria are in particular the need for autonomy between recharging steps, in terms of consumables, the unit cost of the on-board energy consumption, the weight of the tanks for storing the consumables, and the total weight of the generator on board the vehicle.

Now, the inventors have realized that it is possible to find a new and beneficial compromise between these various factors by extracting purer, or almost purer, oxygen from the ambient air on board the vehicle itself using a filtration separation system having no change of state, even if it entails accepting a possible additional weight as a result of such an installation relative to that of an ambient air compression system, such as the one mentioned above. In many cases, this compromise also proves to be more effective than installing a supply of oxidizer gas on board the vehicle. The advantage is all the more pronounced the greater the energy requirements (masses to be moved) and the greater the autonomy (duration/distance to be traveled), as is frequently the case for the usual terrestrial motor vehicles, particularly in applications for heavy goods vehicles, or also even in the case of airborne vehicles.

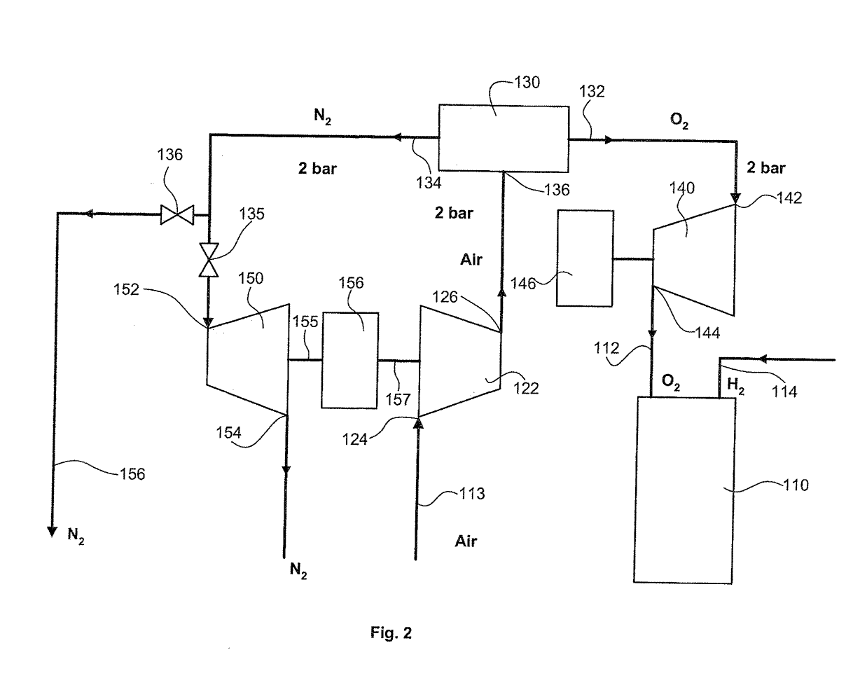

In FIG. 2, a fuel cell 110, for installation on a vehicle (not shown), is supplied with hydrogen via an inlet line 114 and with oxygen-rich oxidizer gas via an inlet line 112. This gas is obtained from a separation of the ambient air into oxygen and nitrogen by an oxygen generator 130, denoted by the acronym OBOGS on board the vehicle.

An intake 113, taking in the ambient air around the vehicle, supplies the inlet 124 of a first compressor 122, called “low-pressure” compressor, the outlet 126 of which delivers, in the present example, compressed air at a pressure of about 2 bar absolute (i.e. 1 bar above atmospheric pressure) to the inlet 136 of the OBOGS generator 130.

The OBOGS generator has an outlet 132, for highly oxygen-enriched gas, connected to the inlet 142 of a second compressor 140, here called a “high-pressure” compressor, the output 144 of which supplies the inlet line 112 of the fuel cell 110 directly at a pressure of about 4 bar absolute, i.e. 3 bar above the ambient atmospheric pressure. The compressor 140 is driven by an electric motor 146 drawing its energy from that delivered in a manner not shown, by the fuel cell. The OBOGS generator 130 includes a second outlet 134, for inert gas very rich in nitrogen. This outlet is connected, on the one hand, via a control valve 135 to the inlet 152 of a turbine 150 which delivers at its outlet 154 a discharge of nitrogen gas expanded to a pressure close to the ambient pressure, and, on the other hand, via another control valve 136 to an outlet line 156 for unexpanded, i.e. high-pressure, nitrogen gas, the purpose of which will be explained later. In accordance with the operation of the OBOGS generator that will be explained below, the pressure of the gases delivered by the OBOGS generator at its outlet 132 (for O₂) and its outlet 134 (for N₂) is about 2 bar absolute in this example. Thus, the turbine 150 which at least partly expands nitrogen gas produced by the OBOGS generator makes it possible to recover or “recuperate”, on its shaft 155, mechanical energy that can be employed for example to help to drive the first compressor 122. This possibility is illustrated schematically by showing a coupling of the output shaft 155 with the output shaft 157 of an electric motor 156 that drives the compressor 122.

The principle of PSA separation relies on the properties of certain materials, especially zeolites, to preferentially adsorb nitrogen from a flow of air delivered at superatmospheric pressure (i.e. a pressure greater than 1 bar), while letting oxygen pass through it without being trapped therein. These materials therefore act as a dry filter and with no change of state, in order to separate the two main constituents of air. When the material of the filter is saturated with nitrogen, it can be regenerated by nitrogen desorption at atmospheric pressure. In practice, the operation is performed by purging the container of the saturated filter with a little oxygen-rich gas produced beforehand during the adsorption phase. It is this pressurization and depressurization cycle that gives its name to the PSA process.

Zeolites are aluminosilicate minerals with a complex crystalline structure. This structure may be compared with that of a cage containing holes on the sides. Molecules of nitrogen under pressure are selectively trapped in the interstices of the structure, and which they penetrate via the holes. The chemical composition of the zeolites that can be used here for the separation application described is the following:

Na₁₂[(AlO₂)₁₂(SiO₂)₁₂].27H₂O

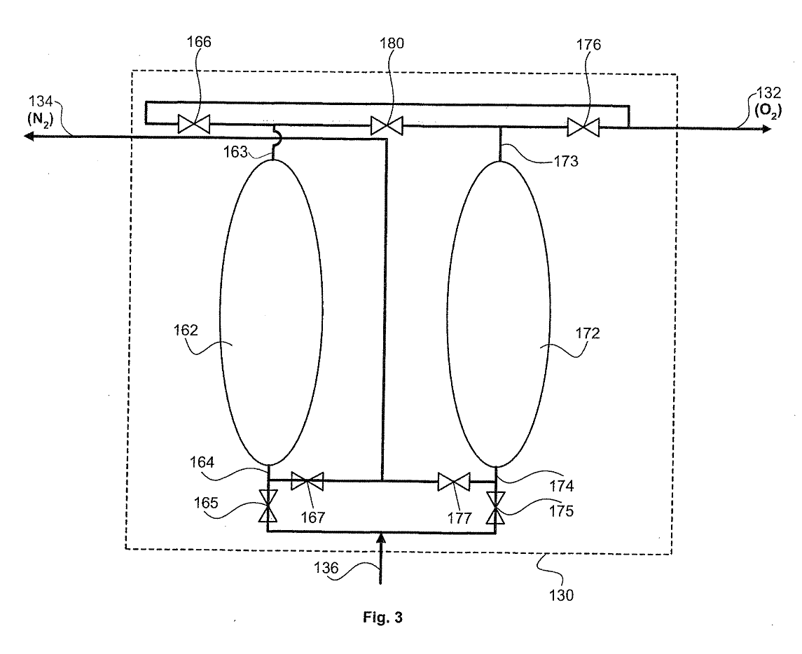

The operation of the OBOGS generator will be described with reference to FIG. 3, which shows the air intake 136 for air compressed to 2 bar absolute of the OBOGS unit 130 and its outlets 132 for the oxygen-enriched gas and the outlet 134 for the nitrogen-rich inert gas. The actual generator is essentially composed of two containers 162 and 172 for filtering by alternate adsorption/desorption. These containers are filled with a zeolite, as explained above. A set of regulating valves is used to control the alternate intake and exhaust cycle that separates the gases of the incoming air by pressure swings.

More specifically, the compressed-air inlet 136 is connected to the inlets 164 and 174 of the two containers 162 and 172, via two valves 165 and 175 respectively. Furthermore, the inlets 164 and 174 of the containers may be selectively connected so as to purge the latter at the end of each cycle, to the nitrogen-rich outlet 134 of the OBOGS via two regulating valves 167 and 177 respectively. The two valves 165 and 175 of the container inlets 164 and 174 are controlled overall in phase opposition, the right-hand container 172, the filter of which has been saturated with pressurized nitrogen gas during a preceding phase, remaining isolated while the left-hand container 162 alone filters, during the next phase, the compressed air taken in at the inlet 136 of the OBOGS unit. The nitrogen of this compressed air is adsorbed by the zeolite during its path through the container 162, which delivers a gas very rich in oxygen (about 95% oxygen) at its outlet 163 and, via a valve 166 open during this phase, to the oxygen outlet 132 of the OBOGS generator.

A valve 176 connects the oxygen outlet 173 of the right-hand filtering container 172 to this same outlet 132. The two oxygen outlets 163 and 173 of these filtering containers are connected together via a valve 180. These two valves 176 and 180 remain closed in almost all the phase that has just been described during which the left-hand container 162 is filtering.

Just before the left-hand container 162 is saturated with nitrogen, the valves 177 and 180 are opened so as to allow, firstly, depressurization of the right-hand container 172, by bringing it into communication with the nitrogen outlet 134, and, secondly, the purging of the nitrogen stored in the zeolites in this same right-hand container with oxygen produced at the outlet 163 of the left-hand container 162. The left-hand container 162 then ends up being saturated with nitrogen, the valve 167 remaining closed.

The next phase then starts with the valves 165, 177, 166 and 180 being closed. The left-hand container 162 is now isolated in the state saturated with pressurized nitrogen. The valve 175 is opened and the valve 177 remains closed. The pressurized air is thus taken into the inlet 174 of the now purged right-hand container 172, while the oxygen outlet valve 176 of this same right-hand container 172 is opened so as to deliver the very oxygen-rich gas to the outlet 132 of the OBOGS unit. The cycle is then repeated in the manner that has just been described.

### EXAMPLES

A supply system according to the invention, given as an example for a 30 kW fuel cell, comprises a stack of 107 individual cell elements each comprising a solid electrolyte polymer membrane with a thickness of about 50 microns and an area of 300 cm². The cell elements can operate at a temperature of 70° C. at a pressure of 4 bar absolute in order to deliver power of about 280 watts at a current of 360 amps. For this power, the fuel cell requires 269 liters of hydrogen per minute and 135 liters of oxygen per minute. In fact, the oxygen flow rate in this example is 155 liters per minute, i.e. about 15% higher than the theoretical requirement. The operating factors specific to the construction of the fuel cell and to the other functions of the oxidizer gas stream, which were mentioned previously in regard to FIG. 1, explain this difference.

It was seen that the oxygen carrier gas was delivered to the inlet 112 of the fuel cell at a pressure of 4 bar absolute by the high-pressure compressor 140, which itself was supplied from gas present at the outlet 132 of the OBOGS generator 130 at a pressure of 2 bar absolute. The compressor consumes 0.3 kW of power for this purpose. For the primary supply of the OBOGS unit with a flow of air compressed to 2 bar absolute, corresponding to the flow required on the outlet 132, the low-pressure compressor 122 consumes 1.5 kW of power. Moreover, the actual OBOGS unit consumes 0.2 kW in order to extract from the air the flow of gas present at its outlet. The total power consumed by the system shown in FIG. 2 for supplying the fuel cell with oxygen oxidizer is therefore 2 kW, i.e. 6.6% of the power delivered by the fuel cell.

In the reference system shown in FIG. 1, in which the fuel cell is supplied directly from the ambient air compressed to 4 atmospheres (4 bar absolute) by a single compressor, the total power needed for this supply rises to about 6 kW, i.e. about 20% of the power produced by the fuel cell. In this case, to obtain, all other things being equal, the desired kW power at the outlet of the fuel cell 110, it is necessary to provide a stack consisting of 214 cell elements instead of 107, since the power that can be produced by each cell element cannot exceed one half of that which can be obtained when the cathode circuits are supplied with pure oxygen instead of a gas several times leaner in oxidizer. Furthermore, the dimensions of supply circuits and internal circuits of the fuel cell and the total available efficiency are negatively affected by the fact that a quantity of gas 5 times greater than the necessary oxygen flow has to be made to pass through the elements of the fuel cell, given the other functions assigned to the gas stream.

In conclusion, the system according to the invention, taken here as an example, makes it possible to achieve an operating energy saving of at least 300%. Furthermore, the system allows the number of necessary cell elements for the fuel cell, and therefore the weight and the cost of the whole assembly, to be halved, knowing that each cell element requires substantial quantities of expensive components (bipolar plates, polymer membranes, GDL (Gas Diffusion Layer) and precious materials, such as platinum).

The system explained above has other advantages. Thus, it is possible in particular to put the presence of a nitrogen-based inert gas at the outlet 134 of the OBOGS generator to good use in two different ways. Firstly, the nitrogen-rich gas at a pressure of 2 bar at the outlet 156 of the system may be used for facilitating and speeding up the process for turning the fuel cell off. Secondly, the inert gas at atmospheric pressure available at the outlet 154 of the turbine 150 can be stored and used to maintain an inert atmosphere around the fuel cell itself or around the entire system. This helps to prevent any incident that might be associated with an accidental leakage or a slow loss of gas intended for supplying the reaction of the fuel cell and liable to constitute an explosive mixture.

Of course, the invention is not limited to the example described and illustrated. In particular, it includes various modifications that may be made thereto without departing from its framework defined by the attached claims.

What is claimed is:

1. An electric power pack comprising:
(1) a fuel cell, which comprises
(a) a stack of individual cell elements, each element comprising a cathode and an anode in electrochemical relationship with an electrolyte, and
(b) electrical output terminals specific for connecting the power pack to an electrical load,
(2) a device for delivering fuel to the fuel cell, and
(3) a system for supplying the fuel cell with an oxygen-based oxidizer gas drawn from ambient air, said system comprising at least one separator for separating components of air by filtration without a change of state.

2. The electric power pack according to claim 1, wherein the separator is a pressure swing adsorption (PSA) generator.

3. The electric power pack according to claim 1, wherein the system for supplying said cell elements with oxidizer gas supplies the gas to the cathode and comprises an inlet compressor for supplying an inlet of the separator with ambient air at a pressure for separating the ambient air into separate components.

4. The electric power pack according to claim 1, wherein the system for supplying said cell elements with oxidizer gas includes a compressor for outputting gas enriched with oxidizer gas for delivering the supply gas to the cathode of each cell element at an optimum pressure.

5. The electric power pack according to claim 2 or claim 3, wherein an inlet pressure of the separator is about 2 bar absolute and a pressure at the cathode inlet of said elements of the fuel cell is about 3 to about 4 bar absolute.

6. The electric power pack according to claim 3, wherein the supply system includes a first outlet for gas rich in oxygen and a second outlet for gas rich in inert elements, wherein the second outlet is connected to a discharge circuit through a mechanical energy recuperator.

7. The electric power pack according to claim 5, wherein the supply system includes a first outlet for gas rich in oxygen and a second outlet for gas rich in inert elements, and wherein the second outlet is connected to a discharge circuit through a mechanical energy recuperator.

8. The electric power pack according to claim 1, wherein the supply system includes a first outlet for gas rich in oxygen and a second outlet for gas rich in elements that are inert with respect to oxidation reactions, and wherein the second outlet is connected to a casing for surrounding the fuel cell with an essentially inert atmosphere.

9. The electric power pack according to claim 1, wherein the supply system includes a first outlet for gas rich in oxygen and a second outlet for gas rich in elements that are inert with respect to oxidation reactions, and wherein the second outlet is suitable for being selectively connected to the gas supply of the fuel cell so as to make it easier to turn it off.

10. A system for supplying oxidizer gas to a hydrogen fuel cell on board a vehicle, comprising (1) a separator, for separating the components of ambient air by filtration, (2) an air compressor, for supplying an inlet of said separator with air at a first superatmospheric pressure, and (3) a compressor for compressing oxygen-rich oxidizer gas available at an outlet of the separator, for supplying an inlet of the fuel cell with oxidizer gas at a second superatmospheric pressure.

11. The supply system according to claim 10, wherein the separator is a pressure swing adsorption (PSA) generator.

12. The system according to claim 10, further comprising an electric traction motor supplied by the fuel cell.

13. A method for supplying consumable material to a hydrogen fuel cell on board a vehicle comprising (1) compressing ambient air to a first superatmospheric pressure, (2) separating the compressed air with a separator to produce a first highly oxygen-enriched gas, (3) compressing the first highly oxygen-enriched gas to a second superatmospheric pressure to produce a second oxygen-enriched gas, and (4) sending the second oxygen-enriched gas to an oxidizer gas inlet of the fuel cell.
